(19) United States
(12) Patent Application Publication
(10) Pub. No.: US 2013/0299713 A1
(43) Pub. Date: Nov. 14, 2013

(54) Multiplier Tube Neutron Detector

(71) Applicants: Kenneth Stephenson, Plainsboro, NJ (US); Christian Stoller, Princeton Junction, NJ (US); Olivier G. Philip, Ewing, NJ (US)

(72) Inventors: Kenneth Stephenson, Plainsboro, NJ (US); Christian Stoller, Princeton Junction, NJ (US); Olivier G. Philip, Ewing, NJ (US)

(73) Assignee: SCHLUMBERGER TECHNOLOGY CORPORATION, Sugar Land, TX (US)

(21) Appl. No.: 13/885,667

(22) PCT Filed: Nov. 11, 2011
(86) PCT No.: PCT/US2011/060303

§ 371 Date: Aug. 5, 2013

Related U.S. Application Data
(60) Provisional application No. 61/413,813, filed on Nov. 15, 2010.

(51) Int. Cl. G01T 3/00

(52) U.S. Cl. CPC G01T 3/00
USPC 250/390.01

(57) ABSTRACT

A neutron detecting device using a neutron-reactive material as the source of charged particles to feed conventional dynode-based electron multiplier which not gas-filled (i.e., with ³He). The detector comprises a neutron-reacting material that produces charged particles, coupled with an electron multiplier that is known for use in photomultipliers. The neutron-reacting material is deposited on a substrate at the entrance to the electron multiplier. Charged particles from the neutron-reacting material impinge on the first dynode of the electron multiplier, where, in turn, electrons are generated. The secondary electrons are collected by a second dynode, and the charge so collected is amplified in each succeeding dynode stage in a cascade effect. The charge pulse from the anode is processed by subsequent pulse processing electronics and counting electronics to provide a count rate that is proportional to the neutron flux incident on the neutron-reacting material.

### TECHNICAL FIELD

The invention relates generally to thermal and epithermal neutron detectors used in the oilfield, including Wireline and Logging-While-Drilling.

### BACKGROUND

Helium-3 (referred to herein as “³He”) is a most important isotope in instrumentation for neutron detection. It has a high absorption cross section for thermal neutron beams and is used as a converter gas in neutron detectors. The neutron is converted through the nuclear reaction

n+³He→³H+¹H+0.764 MeV

into charged particles triton (T, ³H) and proton (p, ¹H) which are detected. ³He provides outstanding performance as a converter in neutron detectors working in ionisation or proportional mode. Its high neutron absorption cross section in combination with high pressure operation allows the design of robust, highly efficient and long-lived neutron detectors. It provides excellent neutron/gamma separation (˜10⁻⁷) and it is non-flammable and nontoxic.

³He is a by-product of Tritium production for use in nuclear weapons. Tritium decays by a radioactive β-decay into ³He with a half life of 12.3 years. It is collected in the occasional tritium cleaning process of stores of tritium. Only the US and Russia are presently providing significant amounts of ³He. With the end of the Cold War, the ³He production from Tritium decay has been reduced significantly. However, since September 2001 the demand of ³He has increased drastically due to security programs launched in the United States and other countries. This has led to a severe depletion of the existing ³He stockpile and caused a shortage of ³He. The availability of ³He for oilfield neutron detectors is decreasing quickly and the price of ³He is escalating rapidly. Consequently, there is a need to find a replacement that will have good detection efficiency of thermal and epithermal neutrons in a small package. Various alternatives to ³He filled detectors have been proposed, including proportional (gas) counters containing a thin layer of boron, lithium, or gadolinium lining the inside wall of the counter. Proportional Technologies of Houston and General Electric are currently marketing boron lined proportional counters. However, single layers of ¹⁰ B provide only relatively low efficiency (˜5%) for thermal neutrons.

Techniques to increase the efficiency using multiple (“soda-straw”) counters have been proposed but these methods are complicated and expensive. Another possibility is a microchannel plate detector, which contains a component of a neutron-reacting material such as ¹⁰B, ⁶Li or Gd. The neutron-reacting material would be incorporated into the glass of the microchannel plate itself. Charged particles produced by the neutron-reacting materials produce electrons within the microchannel plate channels, and these are amplified in the normal way to produce a charge pulse at the output of the microchannel plate. Nova Scientific has patents and pending patent applications on this technology (e.g., U.S. Pat. No. 7,333,701, WO2009/102768).

Another ³He replacement discussed involves using neutron-reacting materials as a source of electrons in gas imaging counters (an imaging variant of the proportional counter). In particular, there are publications on using Gd in a position sensitive gas detector for imaging slow neutrons (see, e.g., Abdushukurov et. al. “Model calculation of efficiency of gadolinium-based converters of thermal neutrons” NIM B84 (1994) p400 and Abdushukurov et. al., “Modeling the registration efficiency of thermal neutrons by gadolinium foils”, IOP Journal of Instrumentation 2 (2007) P04001).

Presently, there is no alternative which could simply replace ³He filled neutron detectors and combine all the capabilities of ³He without a loss in performance.

### BRIEF DESCRIPTION OF THE DRAWINGS

FIG. 1 shows a cut-away view of a multiplier tube neutron detector in accordance with embodiments of the present disclosure.

FIG. 2 shows another multiplier tube neutron detector in accordance with embodiments of the present disclosure.

FIG. 3 shows still another multiplier tube neutron detector in accordance with embodiments of the present disclosure having a non-flat, hemispherical substrate.

FIG. 4 shows yet another multiplier tube neutron detector in accordance with embodiments of the present disclosure having a flat surface with embedded hemispherical surfaces packed either in a quadratic or hexagonal arrangement.

FIG. 5 shows another embodiment of FIG. 4 illustrating how the shape can be changed, allowing for deeper indentations.

FIG. 6 shows another embodiment of FIG. 4 with the application of a potential in the reactive material, by inserting an insulating layer between two layers of conductive neutron reactive materials.

FIG. 7 shows another embodiment of FIG. 4 with the application of a potential in the reactive material, where a higher positive potential is applied to the conductive layer closer to the top of the structure to enhance the extraction of the electrons from the deep pits.

FIG. 8 shows an alternative embodiment of the multiplier tube neutron detector in which the reactive surface is cylindrical with a “squirrel cage” photomultiplier structure.

### DETAILED DESCRIPTION

In the following description, numerous details are set forth to provide an understanding of the present disclosure. However, it will be understood by those skilled in the art that the present invention may be practiced without these details and that numerous variations or modifications from the described embodiments are possible.

We present here a neutron detecting device using a neutron-reactive material as the source of charged particles to feed a conventional dynode-based electron multiplier which is evacuated rather than gas-filled (for example, with ³He). The neutron detector of the present disclosure comprises a neutron-reacting material that produces charged particles, coupled with a conventional electron multiplier that is known for use in photomultipliers. The neutron-reacting material is deposited on a substrate at the entrance to the electron multiplier. Charged particles from the neutron-reacting material impinge on the first dynode of the electron multiplier, where, in turn, secondary electrons are generated. The secondary electrons are collected by a second dynode in the way that electron multipliers conventionally operate. The charge so collected is amplified in each succeeding dynode stage in a cascade effect, so that a charge pulse is produced at the electron multiplier anode that is much larger than the charge produced by the impact on the first dynode. The charge pulse from the anode is processed by subsequent pulse processing electronics and counting electronics to provide a count rate that is proportional to the neutron flux incident on the neutron-reacting material.

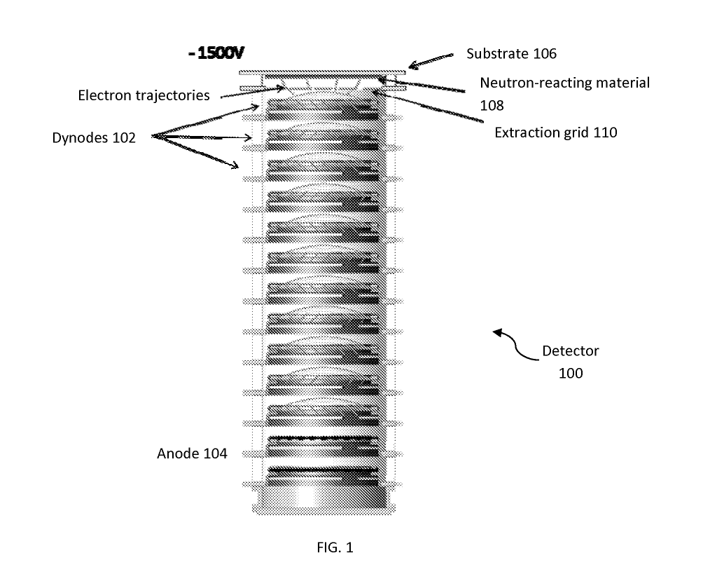

Referring now to FIG. 1, in various embodiments, the multiplier tube neutron detector 100 includes a conventional dynode type electron multiplier having a series of dynodes 102 and an anode 104, a substrate 106 that functions to close the tube and maintain vacuum during operation, a deposit to the substrate 106 of neutron-reacting material 108 such as ¹⁰B, ⁶Li or Gd, and optionally an extraction grid 110 to extract low energy electrons from the layer of neutron-reacting material 108. The neutron-reacting materials showing the most promising results for this application are:

⁶Li+n→³H+⁴He+4780 keV σₜₕₑᵣₘ=940 b

¹⁰B+n→⁷Li*+⁴He+2310 keV σₜₕₑᵣₘ=3840 b

¹⁵⁵Gd→¹⁵⁶Gd+multiple γ-rays and internal conversion electrons σₜₕₑᵣₘ=61000 b

¹⁵⁷Gd→¹⁵⁸Gd+multiple γ-rays and internal conversion electrons σₜₕₑᵣₘ=255000 b

Gd can comprise natural Gd or isotopically separated ¹⁵⁷Gd. The latter isotope is preferable (although more expensive) having a thermal neutron capture cross section of 255000 barns, compared to 49000 barns for natural Gd. The probability of interaction of thermal neutrons in natural Gd and ¹⁵⁷Gd films with subsequent escape of internal conversion electrons has been discussed in detail in refs 2-3 in connection with gas-based imaging systems. In natural Gd films of thickness 5 μm, the probability is 0.10 and, for ¹⁵⁷Gd films of thickness 3 μm, the probability is 0.21.

⁶Li metal has a density of 0.45 and therefore has a nucleus density of approximately 4.5×10²² nuclei/cm³.

Solid ¹⁰B has several crystalline phases with an approximate density of 2.4, leading to a nucleus density of approximately 14.5×10²² nuclei/cm³. B₄C is also a possible material to use, having a boron nucleus density of 11×10²² nuclei/cm³. Given the greater capture cross section and greater nucleus density of ¹⁰B in practical materials, boron is preferred over lithium. The thickness of boron that will still allow ⁴He particles to escape the surface (and therefore generate detectable electrons) is equal to the range of the emitted 1470 keV ⁴He particles, or 3.3 μm in B₄C. In solid ¹⁰B, the range is 3.5 μm. The probability of an interaction for thermal neutrons normally incident on each of these films is 0.14 and 0.19, respectively.

An embodiment of the present disclosure using a thin neutron-reacting film Of ⁶Li, ¹⁰B, ¹⁰B₄C, natural Gd, or ¹⁵⁷Gd is shown in FIG. 1. An extraction grid 110 can optionally be included and biased positively with respect to the neutron-reacting material 108 to accelerate electrons (produced by the charged reaction particles) away from the film and toward the closest dynode in the series of dynodes 102. The extraction grid 110 ensures that a uniform and sufficiently strong extraction field exists at the surface of the neutron-reacting material 108. With respect to the extraction grid 110, the closest dynode (and associated grid) in the series of dynodes 102 is biased positively to ensure that the electrons impact on the closest dynode. The charged particles arriving at the first dynode can be either direct reaction products of the neutron reacting material (e.g., ³H, ⁴He, ⁷Li, internal conversion electrons) or can be secondary electrons produced when the direct reaction products pass through the neutron reacting material 108.

In embodiments wherein an extraction grid is not positioned between the neutron-reacting material and the closest dynode, the closest dynode (and associated grid) is biased positively with respect to the neutron-reacting material 108 to accelerate electrons from the neutron-reacting material 108 toward the dynode. Each successive dynode in the series of dynodes 102 is biased positively with respect to the previous dynode to provide electron multiplication typical of dynode-based electron multipliers. In various embodiments, the neutron-reacting material 108 should be at least slightly conductive so that the electrical potential between the neutron-reacting material 108 and the extraction grid 110 can be maintained.

In various embodiments, each dynode has it's own grid at the same potential as the dynode. There are two purposes to the dynode grid: 1) increasing the extraction field thereby enhancing collection of secondary electrons from the previous dynode, and 2) preventing having a potential barrier on its own dynode (which would prevent electrons from escaping the dynode if the grid were not there).

FIG. 1. illustrates an embodiment with what is known as Venetian blind electron multiplier structure. As shown in FIG. 1, each multiplication stage is comprised of a dynode and a grid. The dynode provides the electron multiplication through secondary electron emission. The grid of provides a low electric field region upstream of the dynode and the grid from the next stage provides a high electric field region downstream of the dynode. These low and high electric fields on each side of the dynode provide the extracting force for the secondary electrons emitted at the dynode surface so that they can leave the dynode and reach the next dynode stage.

The previous material efficiencies assume a flat film of solid neutron-reacting material. Preferably, the thickness of the neutron-reacting material is no thicker than the range of at least one of the reaction products, so that none of the material is “dead” and retaining electrons. Higher efficiencies can be realized if the film is made thicker but with an irregular (and larger) surface. For example, higher efficiency can be obtained with a micro-machined array of “posts”, each with a diameter corresponding to the neutron-reacting material thicknesses described above, so that the charged particles can escape the post and generate electrons. The length of the posts is selected to result in the detection efficiency desired for the neutron energy of interest. Longer posts are preferable for epithermal neutrons since the cross section for capture of epithermal neutrons is smaller than for thermal neutrons.

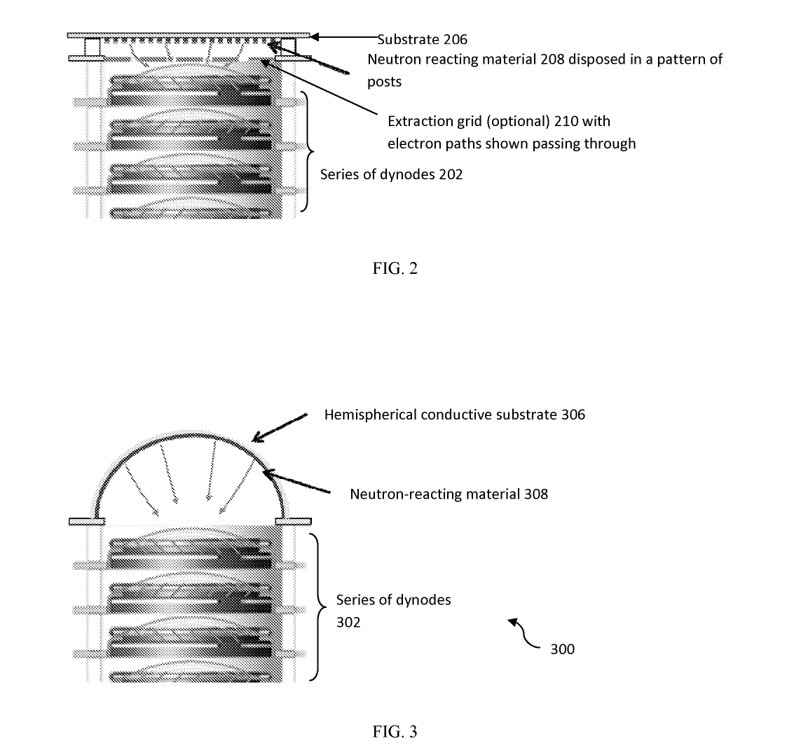

Beyond a certain length, however, the posts will be so long that electrons produced at the base of the post risk not being extracted toward the first (closest) dynode in the series of dynodes. This is due to the weak penetration of electric field between the posts, which are, at least, slightly conductive. The preferred maximum length is estimated to be approximately 10 times the diameter of the posts. By utilizing posts rather than a flat film of neutron-reacting material, the volume of neutron-reactive material presented to the incoming neutron flux is larger and the corresponding detection efficiency is larger, especially for epithermal neutrons with smaller cross-section for capture. An illustration of this embodiment utilizing posts rather than a flat film of neutron-reacting material is shown in FIG. 2.

Alternatively, the volume of neutron-reacting material may also be increased by using a non-flat substrate instead of a flat substrate. In this way, the area of the substrate is increased. One example of a non-flat substrate is shown in the embodiment of FIG. 3, in which the substrate 306 is hemispherical (preferably concave and of a conductive metallic material). The neutron-reacting material 308 can be either smooth (i.e., hemispherically curved) or irregular (e.g., having posts no longer than a preferred maximum length) as previously discussed, and disposed on the substrate 306. In the embodiment of FIG. 3, the closest dynode in the series of dynodes 302 is biased positively with respect to the neutron-reacting material 308 to extract electrons that are emitted by the neutron-reacting material 308. One characteristic of the hemispherical substrate embodiment is that the electrons are naturally focused to the closest dynode in the series 302, and additional focusing electrodes or grids are not necessarily needed.

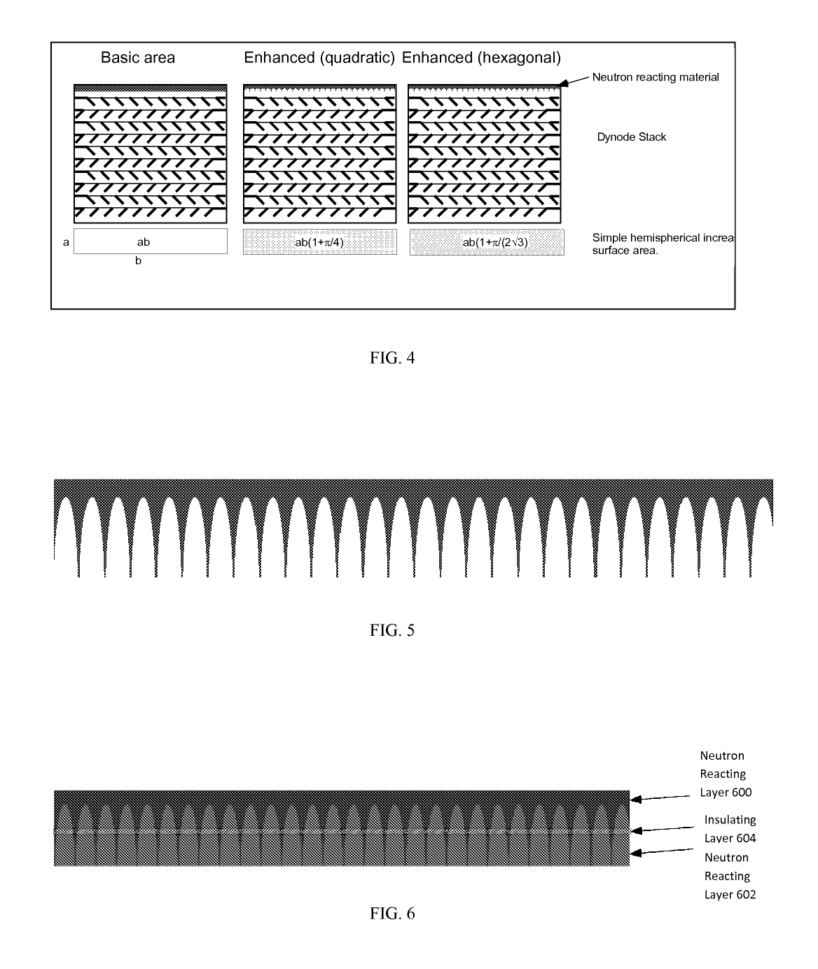

FIG. 4 shows still another alternative embodiment having a flat substrate surface with embedded hemispherical surfaces packed either in a quadratic or a hexagonal arrangement (that is, a quadratic or hexagonal arrangement as viewed from above). A further improvement is embodied in a substrate with the multiple hemispherical indentations to which a thin coating of neutron-reacting material is applied. The thickness of the neutron-reacting material is chosen, as previously mentioned, so that the range of at least one of the reaction products is larger than the thickness of the neutron-reacting material.

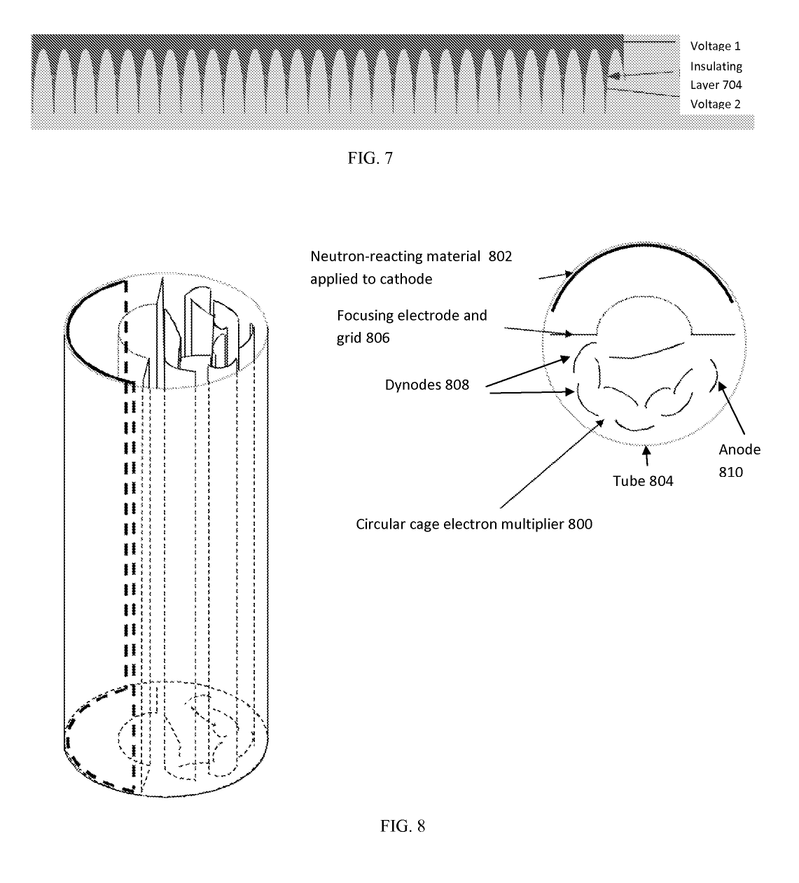

The shape can be changed to make the indentations or craters deeper (as shown in FIG. 5), thereby increasing the total surface area further. Additional shapes in various embodiments are possible. One issue with the approach of using deep craters in a conductive material is that the electric field does not penetrate deep enough and some charged particles may not get extracted. Referring to FIG. 6, this issue can be alleviated by applying a potential across the neutron-reacting material by inserting an insulating layer 604 between two layers of conductive neutron reactive materials 600 and 602 respectively. A higher positive potential (shown as Voltage 1) can then be applied to the conductive layer closer to the top of the substrate structure (while a second Voltage 2 is applied on the other conductive layer on the opposite side of insulating layer 704) to enhance the extraction of the electrons from the deep pits formed between posts (referring to FIG. 7). Alternatively or additionally, an extracting grid may be optionally positioned in front of the reactive material (not shown in FIG. 7) comprising a fine mesh coated by reactive material as well. An additional step includes optionally coating at least the first dynode (closest to the substrate in the tube) with reactive material. In order to optimize the performance, the indentations or similar shapes could be made in the substrate material, which is then covered by a layer of neutron-reactive material of essentially uniform (optimized) thickness. If the surface enhancements are made in the bulk of neutron-reactive material, there will be a substantial neutron-reactive volume, from which the reaction products cannot escape to the surface.

The use of a Venetian blind stack for the electron multiplication makes it possible to build a large area detector, since the dynodes can cover a large area and substantially little or no focusing (i.e. only “proximity focusing) is needed to accelerate the initial electrons to the first closest dynode. The anode can be made position sensitive either by segmenting it or by the use of a position sensitive readout. Other dynode approaches that are known to be suitable for large areas can be considered as well, including box-and-grid, linear-focused, mesh, and micro-machined structures that allow a more compact dynode stack, and thus a thinner detector.

Still another alternate embodiment is shown in FIG. 8, in which the detector 800 includes neutron-reacting material of a semi-cylindrical form surrounded by what is known as a “squirrel cage” photomultiplier structure. Squirrel-cage styled multiplier structures have been in use since at least the 1970s. As shown in FIG. 8, the neutron-reacting material 802 is deposited on the inside surface of the tube 804. The neutron-reacting material 802 can either be a flat layer or can involve some of the previously described approaches that allow an increased surface area and therefore a larger efficiency for incident neutrons. The neutron-reacting material 802 is disposed preferably in a semi-cylindrical form around the inside of and along the length of the tube 804. Optionally (as shown in FIG. 8), a focusing electron and grid 806 is disposed between the neutron-reacting material 802 and the series of dynodes 808 configured in a pattern that is circular when viewed from above. As with the Venetian blind style of multiplier disposed above, in this embodiment with a squirrel-cage geometry, charged particles from the neutron-reacting material 802 impinge on the first dynode in the series of dynodes 808, where, in turn, secondary electrons are generated. The secondary electrons are collected by a each subsequent dynode in the way that electron multipliers conventionally operate. The charge so collected is amplified in each succeeding dynode stage in a cascade effect, so that a charge pulse is produced at the electron multiplier anode 810 that is much larger than the charge produced by the impact on the first dynode.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A multiplier tube neutron detector, comprising:
a vacuum tube and a substrate applied to a portion of the vacuum tube's internal surface;
a neutron-reacting material deposited to the substrate that emits charged particles when impacted by a neutron;
a first dynode on to which the charged particles are directed and where they generate secondary electrons; and
a series of subsequent dynodes that multiply the number of electrons from a preceding dynode through the generation of secondary electrons;
an anode that receives resulting secondary electrons current;
wherein a current pulse is emitted at the anode at a rate proportional to neutron flux incident on the neutron-reacting material.

2. The multiplier tube neutron detector according to claim 1, further comprising an extraction grid positioned between the neutron-reacting material and the series of dynodes.

3. The multiplier tube neutron detector according to claim 2, wherein the extraction grid is biased positively with respect to the neutron-reacting material to accelerate electrons away from the neutron-reacting material, and toward the first dynode in the series

4. The multiplier tube neutron detector according to claim 1, wherein the substrate comprises a metal.

5. The multiplier tube neutron detector according to claim 1, wherein the neutron-reacting material comprises one of ¹⁰B, ⁶Li, Gd, and Gd enriched with the isotope ¹⁵⁷Gd.

6. The multiplier tube neutron detector according to claim 1, wherein the substrate comprises a substantially flat planar surface.

7. The multiplier tube neutron detector according to claim 1, wherein the substrate comprises a hemispherical form.

8. The multiplier tube neutron detector according to claim 1, wherein neutron-reacting material is deposited in a layer of substantially regular thickness on the substrate.

9. The multiplier tube neutron detector according to claim 1, wherein neutron-reacting material is deposited in a pattern in the substrate that increases the available surface area.

10. The multiplier tube neutron detector according to claim 9, wherein neutron-reacting material is deposited in a pattern on an array of posts, each post having a diameter selected so as to permit charged particles to escape and generate electrons.

11. The multiplier tube neutron detector according to claim 9, wherein neutron-reacting material is deposited in a pattern on an array of posts, each post having a length selected to provide a threshold level of detection efficiency for the neutron energy level of interest.

12. The multiplier tube neutron detector according to claim 11, wherein each post has a length that is relatively longer post for detection of epithermal neutrons or relatively shorter for detection of thermal neutrons.

13. The multiplier tube neutron detector according to claim 9, wherein neutron-reacting material is deposited in a pattern on an array of posts, each post having a maximum length of no greater than 10 times the diameter of the post.

14. The multiplier tube neutron detector according to claim 1, each dynode A in the series of dynodes being biased positively with respect to the next-most adjacent dynode B that is positioned in the series of dynodes relatively closer to the neutron-reacting material.

15. The multiplier tube neutron detector according to claim 1, wherein the dynode in the series of dynodes that is positioned closest to the substrate comprises a layer of neutron-reactive material.

16. The multiplier tube neutron detector according to claim 2, wherein the extraction grid further comprises a coating of neutron-reactive material.

17. The multiplier tube neutron detector according to claim 9, wherein the neutron-reacting material is deposited in a pattern having irregular thickness, having a plurality of craters therein.

18. The multiplier tube neutron detector according to claim 17, wherein the neutron-reacting material comprises two layers of conductive neutron-reacting material having a layer of insulation therebetween, configured so as to draw electrons from the plurality of craters when a positive potential is applied.

19. The multiplier neutron tube according to claim 9, wherein the substrate comprises:
a. a first conducting layer separated by an insulating layer from a second conducting layer, and
wherein one surface of the substrate comprises a plurality of indentations that penetrate the first conducting layer; and
b. further comprising a layer of neutron reactive material of substantially uniform thickness deposited on the two conducting layers.

20. The multiplier neutron tube according to claim 19, wherein an electric potential is applied between the first conducting layer and the second conducting layer causing extraction of electrons generated in the second conducting layer toward the outside of the indentations penetrating the first conducting layer.

21. The multiplier tube neutron detector according to claim 1, wherein the series of dynodes comprises one of the following structure types: Venetian blind, box-and-grid, linear focused, squirrel cage, micromachined.

22. The multiplier neutron detector according to claim 19, further comprising an elongated detector geometry, wherein the neutron reacting material is deposited lengthwise along one side of the detector.
